(19) United States
(12) Patent Application Publication
(10) Pub. No.: US 2025/0356110 A1
(43) Pub. Date: Nov. 20, 2025

(54) INTERACTION METHOD, APPARATUS AND DEVICE, AND STORAGE MEDIUM

(71) Applicants: Lemon Inc., Grand Cayman (KY); Beijing Zitiao Network Technology Co., Ltd., Beijing (CN)

(72) Inventors: Zichun Wang, Culver City, CA (US); Yue Chen, Beijing (CN); Kin Chung Wong, Los Angeles, CA (US); Hao Qiu, Beijing (CN); Siyuan Chen, Culver City, CA (US); Jonathan Guzi, Culver City, CA (US); You Xie, Los Angeles, CA (US); Linjie Luo, Los Angeles, CA (US)

(21) Appl. No.: 19/214,284

(22) Filed: May 21, 2025

Related U.S. Application Data
(63) Continuation of application No. PCT/CN2024/094311, filed on May 20, 2024.

(51) Int. Cl. G06F 40/166; G06F 3/0484; H04L 51/046

(52) U.S. Cl. CPC G06F 40/166; G06F 3/0484; H04L 51/046

(57) ABSTRACT

Embodiments of the disclosure relate to an interaction method, apparatus, device and storage medium. The method proposed herein includes: in response to receiving a sharing request for an avatar created by a user, presenting a sharing window, wherein the sharing window includes a message editing component, the message editing component includes a text region and a resource region, and at least one of the text region or the resource region is an editable region supporting content editing; generating a target message based on an input content of the message editing component, wherein the target message includes a text content in the text region and at least one interaction resource in the resource region; and sending the target message to a session associated with at least one object to be shared.

### CROSS-REFERENCE

This application claims priority to PCT Application No. PCT/CN2024/094311 filed on May 20, 2024, and entitled “INTERACTION METHOD, APPARATUS AND DEVICE, AND STORAGE MEDIUM”, which is incorporated herein by reference in their entireties.

### FIELD

Example embodiments of the present disclosure generally relate to the field of computers, and in particular, to an interaction method, apparatus, device, and computer-readable storage medium.

### BACKGROUND

In recent years, with the development of the Internet, more and more users carry out network activities in an application platform. The user may set their own avatar in the application platform as a way to express themselves.

### SUMMARY

In a first aspect of the present disclosure, a method for interaction is provided. The method comprises:

in response to receiving a sharing request for an avatar created by a user, presenting a sharing window, wherein the sharing window comprises a message editing component, the message editing component comprises a text region and a resource region, and at least one of the text region or the resource region is an editable region supporting content editing; generating a target message based on an input content of the message editing component, wherein the target message comprises a text content in the text region and at least one interaction resource in the resource region, and the at least one interaction resource is generated based on the created avatar; and sending the target message to a session associated with at least one object to be shared.

In a second aspect of the present disclosure, an apparatus for interaction is provided. The apparatus comprises:
a presentation module, configured to, in response to receiving a sharing request for an avatar created by a user, present a sharing window, wherein the sharing window comprises a message editing component, the message editing component comprises a text region and a resource region, and at least one of the text region and the resource region is an editable region supporting content editing; a generation module, configured to generate a target message based on an input content of the message editing component, wherein the target message comprises a text content in the text region and at least one interaction resource in the resource region, and the at least one interaction resource is generated based on the created avatar; and a sending module, configured to send the target message to a session associated with at least one object to be shared.

In a third aspect of the present disclosure, an electronic device is provided. The device comprises: at least one processor; and at least one memory coupled to the at least one processor and storing instructions to be executed by the at least one processor, the instruction, when executed by the at least one processor, cause the electronic device to perform the method of the first aspect.

In a fourth aspect of the present disclosure, a computer readable storage medium is provided, where the computer readable storage medium has a computer program stored thereon, and the computer program is executed by a processor to implement the method of the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar drawing reference numerals denote the same or similar elements, wherein:

FIG. 1 illustrates a schematic diagram of an example environment capable of implementing some embodiments of the present disclosure;

FIGS. 2A-2C illustrate example interfaces according to some embodiments of the present disclosure;

FIG. 3 illustrates a flowchart of an example process of interaction according to some embodiments of the disclosure;

FIG. 4 illustrates a schematic structural block diagram of an example apparatus for interaction according to some embodiments of the disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the titles of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as open-ended including, that is, “including but not limited to”. The term “based on” should be read as “based at least in part on.” The term “one embodiment” or “the embodiment” should be read as “at least one embodiment.” The term “some embodiments” should be understood as “at least some embodiments.” Other explicit and implicit definitions may also be included below. The terms “first”, “second”, etc. may refer to different or identical objects. Other explicit and implicit definitions may also be included below.

Embodiments of the present disclosure may relate to data, acquisition and/or use of data, etc. by a user, all following respective legal regulations and related regulations. In embodiments of the present disclosure, all data collection, acquisition, processing, handling, forwarding, use, and the like, are made with user knowledge and confirmation. Accordingly, when implementing the embodiments of the present disclosure, the user should be informed of the types of data or information that may be involved, a usage range, a usage scenario, and the like in an appropriate manner according to relevant legal regulations, and the authorization of the user is obtained. The specific informing and/or authorization manner may vary according to actual situations and application scenarios, and the scope of the present disclosure is not limited in this aspect.

In the present description and the embodiments, the personal information processing is performed on the basis of legitimacy (for example, obtaining the consent of the personal information body, or being necessary for fulfillment of a contract, etc.), and is performed only within a prescribed range or a predetermined range. The user rejects personal information other than the necessary information required for processing the basic function, and the use of the basic function by the user is not affected.

As mentioned briefly above, the user may set their own avatar in the application platform as a way to express themselves. People expect to enrich the content of information sent by themselves by means of avatar.

Embodiments of the present disclosure provide a solution for interaction. According to the solution, a sharing window may be presented in response to receiving a sharing request for an avatar created by a user. The sharing window comprises a message editing component, the message editing component comprises a text region and a resource region, and at least one of the text region or the resource region is an editable region supporting content editing. A target message is generated based on an input content of the message editing component, wherein the target message comprises text content in the text region and at least one interaction resource in the resource region, and the at least one interaction resource is generated based on the created avatar. and the target message is sent to a session associated with the at least one object to be shared.

In this way, embodiments of the present disclosure can provide a user with a way of generating message content including an avatar, so that the user can conveniently create and send the message content including the avatar. Thus, the efficiency of sharing a message by a user is improved, thereby improving the user experience.

Various example implementations of the solution are described in further detail below with reference to the accompanying drawings.

### Example Environment

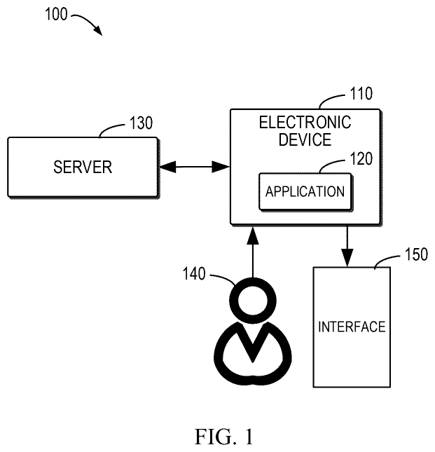

FIG. 1 shows a schematic diagram of an example environment 100 in which embodiments of the present disclosure can be implemented. As shown in FIG. 1, the example environment 100 can include an electronic device 110.

In this example environment 100, the electronic device 110 can run an application 120 that supports interface interaction. The application 120 can be any suitable type of application for interface interaction, examples of which can include, but are not limited to, video applications, social applications, or other suitable applications. User 140 may interact with application 120 via electronic device 110 and/or an attached device thereof.

In the environment 100 of FIG. 1, if the application 120 is active, the electronic device 110 may present an interface 150 through the application 120 to support interface interaction.

In some embodiments, electronic device 110 communicates with server 130 to enable the provision of services to application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a Personal Communication System (PCS) device, personal navigation device, personal digital assistant (PDA), audio/video player, digital camera/camcorder, positioning device, television receiver, radio broadcast receiver, electronic book device, game device, or any combination of the foregoing, including accessories and peripherals for these devices, or any combination thereof. In some embodiments, electronic device 110 can also support any type of interface for a user (such as a ‘wearable’ circuit or the like).

The server 130 may be an independent physical server, may also be a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. Server 130 may include, for example, a computing system/server, such as a mainframe, an edge computing node, a computing device in a cloud environment, etc. The server 130 may provide background services for the application 120 that supports virtual scenarios in the electronic device 110.

A communication connection may be established between the server 130 and the electronic device 110. The communication connection may be established by a wired means or a wireless means. Communication connections may include, but are not limited to, Bluetooth connections, mobile network connections, Universal Serial Bus (USB) connections, Wireless Fidelity (WiFi) connections, and the like, to which embodiments of the present disclosure are not limited. In embodiments of the present disclosure, the server 130 and the electronic device 110 may realize signaling interaction through a communication connection therebetween.

It should be understood that the structure and function of the various elements in environment 100 are described for exemplary purposes only, and are not intended to imply any limitation on the scope of the disclosure.

Some example embodiments of the present disclosure will be described below with continued reference to the accompanying drawings.

### Example Interactions

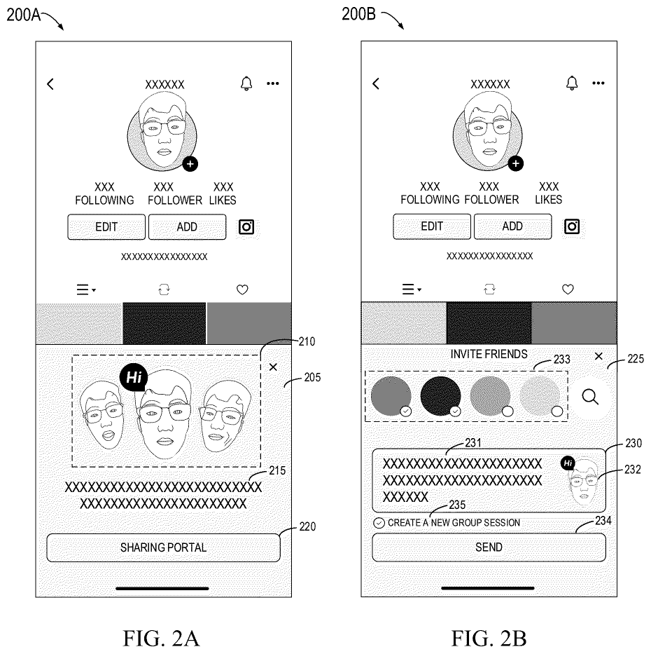

FIGS. 2A-2C illustrate example interfaces 200A-200C, according to some embodiments of the disclosure. The interfaces 200A-200C, for example, may be provided by the electronic device 110 shown in FIG. 1.

In some embodiments, as shown in FIG. 2A, electronic device 110 may present a prompt window 205 in display interface 200A in response to completing the creation of the corresponding avatar by the user. As an example, as shown in FIG. 2A, display interface 200A may be a personal detail page of a user in application 120. It should be noted that, the display interface 200A presenting the prompt window here is only an exemplary illustration of a personal details page, and the display interface 200A may also be, for example, a work browsing page, a message session interface, and the like. Specific content of the display interface 200A is not limited in the present disclosure.

In some embodiments, the avatar creation process may include the server 130 obtaining at least one reference image based on a configuration operation of the user. As an example, the configuration operation may include selecting an image from an album or taking an image with a camera component. By way of example, the reference image may be an image in an album or an image taken by a camera component.

In some embodiments, the visual model may be a three-dimensional model obtained based on a reference image, and the visual model may be obtained by invoking a preset model to process at least one reference image. The preset model may be implemented as any model capable of converting a two-dimensional image into a three-dimensional model, and specific content of the preset model is not limited in the present disclosure. In some embodiments, the generated visual model may also be referred to as a digital or virtual distraction of the user.

In some embodiments, the avatar may be an action process (for example, a click action process and a head shaking action process) corresponding to the visual model, that is, the dynamic image content. In some embodiments, the avatar may also be a static representation of the visual model (e.g., a happy expression, a sad expression, etc.), that is, the static image content.

In some embodiments, with continued reference to FIG. 2A, the electronic device 110 can present at least one interaction resource 210 associated with the avatar created by the user in the prompt window 205. The at least one interaction resource may be generated based on the created avatar. As an example, the at least one interaction resource 210 may be at least one image content (e.g., an image content comprised of an avatar, a text, a sticker, etc.) associated with the avatar capable of expressing an emotional state (e.g., a laughter expression, a crying expression, etc.).

In some embodiments, with continued reference to FIG. 2A, electronic device 110 may also present prompt text 215 in prompt window 205. As an example, the prompt text 215 may prompt the user to share the created avatar. For example, the prompt text 215 may include: ‘You can publish the avatar or share to other users.’

In some embodiments, with continued reference to FIG. 2A, the electronic device 110 may also present the sharing portal 220 in the prompt window 205. By way of example, the sharing portal 220 may be used to share avatar to other users or to publish works including avatar.

In some embodiments, with continued reference to FIG. 2A, the electronic device 110 may receive the sharing request for the avatar created by the user in response to triggering the sharing portal 220. It can be understood that receiving the sharing request in response to triggering the sharing portal 220 is only illustrative. Electronic device 110 may also receive the sharing request for the avatar created by the user based on other means (e.g., a click operation on the avatar, etc.).

In some embodiments, as shown in FIG. 2B, electronic device 110 may present sharing window 225 on display interface 200B in response to receiving a sharing request for an avatar created by the user. Sharing window 225 includes message editing component 230. Message editing component 230 includes text region 231 and resource region 232.

In some embodiments, at least one of the text region 231 and the resource region 232 is an editable region supporting content editing. As an example, the text region 231 is, for example, an editable region, then the user may customarily edit the text content within the text region 231. The text region 231 is, for example, a non-editable region, and therefore, the text content in the text region 231 is a preset text content that cannot be changed. As an example, the resource region 232 is, for example, an editable region, then the user may customarily modify the interaction resources within the resource region 232. The resource region 232 is, for example, a non-editable region, and the interaction resource in the resource region 232 is a preset interaction resource that cannot be changed.

In some embodiments, with continued reference to FIG. 2B, the electronic device 110 may configure the presentation of the initial text content in the text region 231 in response to the presentation of the sharing window 225; and/or configure the presentation of an initial interaction resource in the resource region 232.

In some embodiments, with continued reference to FIG. 2B, when the text region 231 is an editable region that supports content editing, the electronic device 110 may modify the initial text content in the text region 231 based on a received first editing operation (e.g., a click operation on the text region 231).

In some embodiments, with continued reference to FIG. 2B, when the resource region 232 is an editable region that supports content editing, the electronic device 110 may modify an initial interaction resource in the resource region 232 based on a received second editing operation (e.g., a click operation on the resource region 232).

In some embodiments, with continued reference to FIG. 2B, modifying, by the electronic device 110, the initial interaction resource in the resource region 232 may include replacing the initial interaction resource with a first interaction resource. As an example, the electronic device 110 may present a set of preset interaction resources in response to receiving a click operation on the resource region 232. The set of preset interaction resources may include a plurality of interaction resources. Further, the electronic device 110 may replace the initial interaction resource in the resource region 232 with the first interaction resource in response to selecting the first interaction resource in the set of preset interaction resources.

In some embodiments, with continued reference to FIG. 2B, modifying, by the electronic device 110, the initial interaction resource in the resource region 232 may include adding a second interaction resource to the resource region. As an example, the electronic device 110 may present a set of preset interaction resources in response to receiving a click operation on the resource region 232. The set of preset interaction resources may include a plurality of interaction resources. Further, in response to selectin ga second interaction resource in the set of preset interaction resources, the electronic device 110 may add the second interaction resource to the resource region 232 on the premise of maintaining existence of the initial interaction resource.

In some embodiments, with continued reference to FIG. 2B, modifying, by the electronic device 110, the initial interaction resource in the resource region 232 may include deleting a third interaction resource in the resource region 232. It is understandable that the third interaction resource herein may refer to any interaction resource presented in the resource region 232. As an example, the electronic device 110 may, in response to receiving a preset operation (e. g., a long press operation, etc.) on the third interaction resource, provide a delete control to delete the third interaction resource or delete the third interaction resource directly in the resource region 232.

In some embodiments, with continued reference to FIG. 2B, the electronic device 110 can generate the target message based on the input content of the message editing component 230. In some embodiments, the target message may include text content in a text region and at least one interaction resource in a resource region.

In some embodiments, with continued reference to FIG. 2B, electronic device 110 can also present a set of candidate objects 233 in sharing window 225. A set of candidate objects 233 may include a user object and/or a group object (e.g., a group object consisting of multiple user objects that may collectively receive a message).

In some embodiments, with continued reference to FIG. 2B, the electronic device 110 can receive a selection for at least one object of a set of candidate objects (e.g., realizing selection of the at least one object by a click operation). Further, the electronic device 110 may send the target message to the session associated with the at least one object to be shared, based on the selection of the at least one object. As an example, as shown in display interface 200B of FIG. 2B, electronic device 110 can provide sending controls 234 in sharing window 225. Further, electronic device 110 may send the target message to the session associated with the at least one object to be shared in response to triggering the sending control 234.

In some embodiments, with continued reference to FIG. 2B, at least one object includes a plurality of objects, and sending, by the electronic device 110, a target message to a session associated with the at least one object to be shared includes sending the target message to a plurality of sessions corresponding to the plurality of objects respectively. As an example, electronic device 110 may send the target message in a private session corresponding to a user object of the at least one object (i.e., a session including only the target user and the user object). Electronic device 110 may also send the target message in a set session corresponding to a group object of the at least one object (e.g., a session in which multiple objects in the set may receive and send messages).

In some embodiments, with continued reference to FIG. 2B, the at least one object includes multiple objects, and sending, by the electronic device 110, the target message to the session associated with the at least one object to be shared includes creating a new session associated with the multiple objects. Further, electronic device 110 sends the target message to the created new session. As an example, the plurality of objects include at least one user object and at least one group object, where the at least one group object includes a plurality of user group objects. As an example, electronic device 110 creates a new session associated with multiple objects, e.g., creates a new group session based on all of at least one object. The new group session includes at least one user object and a plurality of user group objects.

In some embodiments, with continued reference to display interface 200B of FIG. 2B, electronic device 110 provides a configuration control 235 in sharing window 225. Further, the electronic device 110 may receive a selection of a configuration control 235, receiving a session creation request. Further, electronic device 110 may create a new session associated with the plurality of objects based on the session creation request.

In some embodiments, with continued reference to FIG. 2B, in response to the number of the plurality of objects selected being greater than a preset threshold, the electronic device 110 presents a configuration control 235 in the sharing window 225. As an example, the preset threshold is, for example, 3, when the number of the selected plurality of objects is less than 3, electronic device 110 does not present configuration controls 235 in sharing window 225. The present disclosure does not limit the specific number of preset thresholds.

In some embodiments, as shown in FIG. 2C, the electronic device 110 may trigger a client associated with the at least one object to present a session interface 200C in a session based on a preset operation (e.g., a click operation on the session). Further, electronic device 110 may present target message 240 in session interface 200C.

In some embodiments, with continued reference to FIG. 2C, the electronic device 110 may also present the interaction portal 245 associated with the target message 240 in the session interface 200C in response to satisfying the preset condition. As an example, the electronic device 110 may provide a text content that introduces the functionality of the interaction portal 245.

In some embodiments, with continued reference to FIG. 2C, the avatar previously created by the user is referred to as the first avatar. The electronic device 110 may create a corresponding second avatar in response to the at least one object, presenting a first interaction portal in the session interface 200C. The first interaction portal is used for generating an interaction resource corresponding to the second avatar. As an example, in response to the triggering (for example, a click operation) of the first interaction portal by at least one object, the electronic device 110 may present a setting interface for guiding at least one object to create an interaction resource corresponding to the second avatar. The setting interface may support the at least one object to edit the second avatar (for example, adjusting the size, cutting, adding text, stickers, etc.), so that the at least one object creates an interaction resource corresponding to the second avatar.

In some embodiments, with continued reference to FIG. 2C, the avatar previously created by the user is referred to as the first avatar. The electronic device 110 may present a second interaction portal in the session interface 200C in response to at least one object not creating a corresponding avatar. The second interaction portal may be used for creating an avatar corresponding to the at least one object. For example, in response to triggering the second interaction portal by the at least one object, the electronic device 110 may present a creation interface for guiding the creation of the corresponding avatar by the at least one object. The creation interface may support at least one object to import a reference image, so that the at least one object creates an avatar corresponding to the reference image.

Based on the above-described process, embodiments of the present disclosure can support a user to send a message based on an interaction resource corresponding to an avatar, and guide other users to create the avatar or the interaction resource corresponding to the avatar. In this way, the efficiency and interestingness of sharing a message by a user can be improved, and a user can also be assisted to experience related functions of an avatar in his/her hands quickly, thereby improving the user experience.

### Example Processes

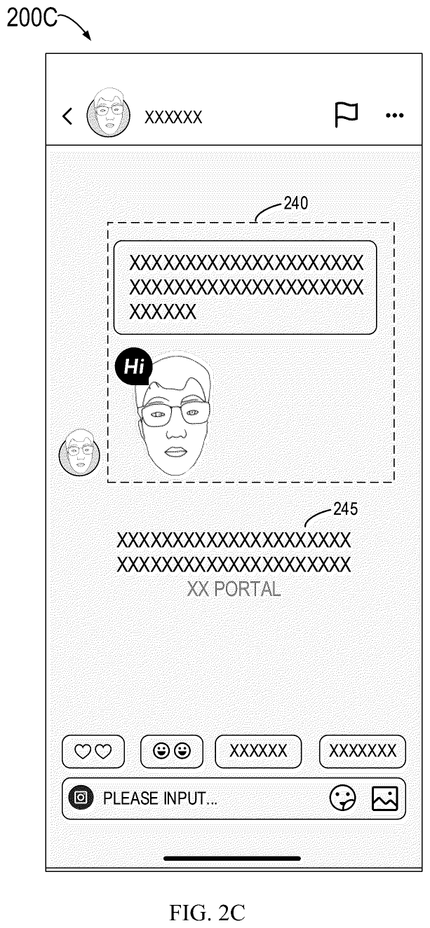

FIG. 3 shows a flowchart of an example process 300 of interaction according to some embodiments of the present disclosure. Process 300 may be implemented at electronic device 110. Process 300 is described below with reference to FIG. 1.

As shown, in block 310, the electronic device 110, in response to receiving a sharing request for an avatar created by a user, presents a sharing window, wherein the sharing window comprises a message editing component, the message editing component comprises a text region and a resource region, and at least one of the text region or the resource region is an editable region supporting content editing.

In block 320, the electronic device 110, generates a target message based on an input content of the message editing component, wherein the target message comprises a text content in the text region and at least one interaction resource in the resource region, and the at least one interaction resource is generated based on the created avatar.

In block 330, electronic device 110 sends the target message to a session associated with at least one object to be shared.

In some embodiments, method 300 further comprises triggering a client associated with the at least one object to present the target message and an interaction portal associated with the target message in a session interface of the session.

In some embodiments, the avatar is a first avatar, and in response to that the at least one object has a corresponding second avatar, the interaction portal comprises a first interaction portal, and the first interaction portal is used to generate an interaction resource corresponding to the second avatar; or in response to that the at least one object has no a corresponding avatar, the interaction portal comprises a second interaction portal, and the second interaction portal is used to generate an avatar corresponding to the at least one object.

In some embodiments, method 300 further comprises: presenting a set of candidate objects in the sharing window, wherein the set of candidate objects comprises a user object and/or a group object; and receiving a selection for the at least one object in the set of candidate objects.

In some embodiments, the at least one object comprises a plurality of objects, and sending the target message to the session associated with at least one object to be shared comprises: creating a new session associated with the plurality of objects; and sending the target message to the created new session.

In some embodiments, creating a new session associated with the plurality of objects comprises: receiving a session creation request based on a configuration control in the sharing window; and creating the new session associated with the plurality of objects based on the session creation request.

In some embodiments, the at least one object includes a plurality of objects, and sending the target message to a session associated with the at least one object to be shared comprises sending the target message to a plurality of sessions corresponding to the plurality of objects respectively.

In some embodiments, the text region is configured to present an initial text content; and/or the resource region is configured to present an initial interaction resource.

In some embodiments, the method 300 further comprises: modifying the initial text content in the text region based on a received first editing operation; and/or modifying the initial interaction resource in the resource region based on a received second editing operation.

In some embodiments, modifying the initial interaction resource in the resource region comprises at least one of: replacing the initial interaction resource with a first interaction resource; adding a second interaction resource to the resource region; deleting a third interaction resource in the resource region.

### Example Apparatus and Devices

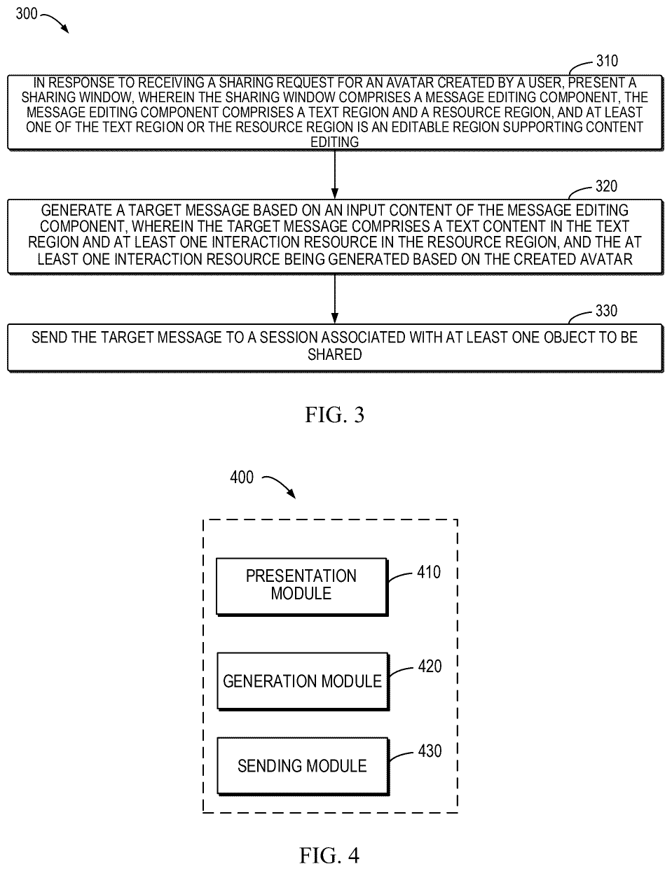

Embodiments of the present disclosure also provide corresponding apparatus for implementing methods or processes described above. FIG. 4 illustrates a schematic structural block diagram of an example apparatus 400 for interaction according to some embodiments of the present disclosure. The apparatus 400 may be implemented as or included in an electronic device. The various modules/components in the apparatus 400 may be implemented by hardware, software, firmware, or any combination thereof.

As shown in FIG. 4, the apparatus 400 comprises a presentation module 410, configured to, in response to receiving a sharing request for an avatar created by a user, present a sharing window, wherein the sharing window comprises a message editing component, the message editing component comprises a text region and a resource region, and at least one of the text region or the resource region is an editable region supporting content editing; a generation module 420, configured to generate a target message based on an input content of the message editing component, wherein the target message comprises a text content in the text region and at least one interaction resource in the resource region, and the at least one interaction resource is generated based on the created avatar; and a sending module 430, configured to send the target message to a session associated with at least one object to be shared.

In some embodiments, apparatus 400 further comprises a session presentation module configured to trigger a client associated with the at least one object to present the target message and an interaction portal associated with the target message in a session interface of the session.

In some embodiments, the avatar is a first avatar; in response to that the at least one object has a corresponding second avatar, the interaction portal comprises a first interaction portal, and the first interaction portal is used to generate an interaction resource corresponding to the second avatar; or in response to that the at least one object has no a corresponding avatar, the interaction portal comprises a second interaction portal, and the second interaction portal is used to generate an avatar corresponding to the at least one object.

In some embodiments, the presentation module 410 is further configured to: present a set of candidate objects in the sharing window, wherein the set of candidate objects comprises a user object and/or a group object; and receive a selection for the at least one object in the set of candidate objects.

In some embodiments, the at least one object comprises a plurality of objects; the sending module 430 is further configured to: create a new session associated with the plurality of objects; and send the target message to the created new session.

In some embodiments, the sending module 430 is further configured to: c receive a session creation request based on a configuration control in the sharing window; and create the new session associated with the plurality of objects based on the session creation request.

In some embodiments, the at least one object comprises a plurality of objects. The sending module 430 is further configured to: send the target message to a plurality of sessions corresponding to the plurality of objects respectively.

In some embodiments, the text region is configured to present an initial text content; and/or the resource region is configured to present an initial interaction resource.

In some embodiments, the generation module 420 is further configured to: modify the initial text content in the text region based on a received first editing operation; and/or modify the initial interaction resource in the resource region based on a received second editing operation.

In some embodiments, the generation module 420 is further configured to: replace the initial interaction resource with a first interaction resource; add a second interaction resource to the resource region; delete a third interaction resource in the resource region.

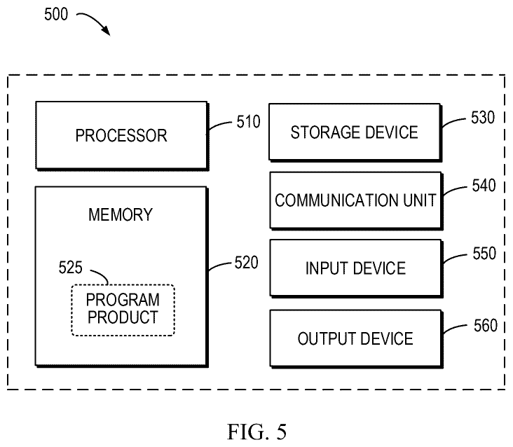

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 can be used in an electronic device.

As shown in FIG. 5, the electronic device 500 is in the form of a generic electronic device. The components of the electronic device 500 may include, but are not limited to, one or more processing units or processors 510, memory 520, storage device 530, one or more communication units 540, one or more input devices 550, and one or more output devices 560. The processor 510 may be a real or virtual processor and may be capable of performing various processes according to programs stored in the memory 520. In a multiprocessor system, a plurality of processors execute computer executable instructions in parallel to improve the parallel processing capability of the electronic device 500.

The electronic device 500 typically includes a plurality of computer storage media. Such media may be any available media that is accessible to the electronic device 500, including, but not limited to, volatile and non-volatile media, removable and non-removable media. Memory 520 may be volatile memory (e.g., registers, cache, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium such as a flash drive, a magnetic disk, or any other medium that may be used to store information and/or data and that may be accessed within electronic device 500.

The electronic device 500 may further comprise additional removable/non-removable, volatile/nonvolatile storage media. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. Memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Accordingly, the electronic device 500 may operate in a networked environment using logical connections to one or more other servers, network personal computers (PCs), or another network node.

Input device 550 may be one or more input devices such as a mouse, keyboard, trackball, etc. Output device 560 may be one or more output devices such as a display, speakers, printer, etc. The electronic device 500 may also communicate with one or more external devices (not shown), such as storage devices, display devices, etc., as needed through the communication unit 540, with one or more devices that enable a user to interact with the electronic device 500, or with any device (e.g., network card, modem, etc.) that enables the electronic device 500 to communicate with one or more other electronic devices. Such communication may be performed via an input/output (I/O) interface (not shown).

According to an exemplary implementation of the present disclosure, a computer-readable storage medium is provided, on which a computer-executable instruction is stored, wherein the computer-executable instruction is executed by a processor to implement the above-described method. According to an exemplary implementation of the present disclosure, there is also provided a computer program product, which is tangibly stored on a non-transitory computer-readable medium and includes computer-executable instructions that are executed by a processor to implement the method described above.

Aspects of the present disclosure are described herein with reference to flowchart illustrations and/or block diagrams of methods, apparatus, devices and computer program products implemented according to the present disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, programmable data processing apparatus, and/or other devices to function in a particular manner, such that the computer-readable medium storing the instructions includes an article of manufacture including instructions which implement various aspects of the functions/acts specified in the flowchart and/or block diagram block or blocks.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions which execute on the computer, other programmable data processing apparatus, or other devices implement the functions/acts specified in the flowchart and/or block diagram block or blocks.

The flowchart and block diagrams in the Figures illustrate the architecture, functionality, and operation of possible implementations of systems, methods and computer program products according to various implementations of the present disclosure. In this regard, each block in the flowchart or block diagrams may represent a module, segment, or portion of an instruction which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described implementations of the disclosure above, the foregoing description is exemplary, not exhaustive, and is not limited to the implementations disclosed. Many modifications and variations will be apparent to those of ordinary skill in the art without departing from the scope and spirit of the implementations described. The choice of terms used herein is intended to best explain the principles of the implementations, the practical application, or improvements to technologies in the marketplace, or to enable others of ordinary skill in the art to understand the implementations disclosed herein.

What is claimed is:

1. A method for interaction, comprising:
in response to receiving a sharing request for an avatar created by a user, presenting a sharing window, wherein the sharing window comprises a message editing component, the message editing component comprises a text region and a resource region, and at least one of the text region or the resource region is an editable region supporting content editing;
generating a target message based on an input content of the message editing component, wherein the target message comprises a text content in the text region and at least one interaction resource in the resource region, and the at least one interaction resource is generated based on the created avatar; and
sending the target message to a session associated with at least one object to be shared.

2. The method of claim 1, further comprising:
triggering a client associated with the at least one object to present the target message and an interaction portal associated with the target message in a session interface of the session.

3. The method of claim 2, wherein the avatar is a first avatar;
in response to that the at least one object has a corresponding second avatar, the interaction portal comprises a first interaction portal, and the first interaction portal is used to generate an interaction resource corresponding to the second avatar; or
in response to that the at least one object has no a corresponding avatar, the interaction portal comprises a second interaction portal, and the second interaction portal is used to generate an avatar corresponding to the at least one object.

4. The method of claim 1, further comprising:
presenting a set of candidate objects in the sharing window, wherein the set of candidate objects comprises a user object and/or a group object; and
receiving a selection for the at least one object in the set of candidate objects.

5. The method of claim 1, wherein the at least one object comprises a plurality of objects, and sending the target message to the session associated with at least one object to be shared comprises:
creating a new session associated with the plurality of objects; and
sending the target message to the created new session.

6. The method of claim 5, wherein creating a new session associated with the plurality of objects comprises:
receiving a session creation request based on a configuration control in the sharing window; and
creating the new session associated with the plurality of objects based on the session creation request.

7. The method of claim 1, wherein the at least one object comprises a plurality of objects, and sending the target message to a session associated with at least one object to be shared comprises:
sending the target message to a plurality of sessions corresponding to the plurality of objects respectively.

8. The method of claim 1, wherein comprising at least one of:
the text region is configured to present an initial text content; or
the resource region is configured to present an initial interaction resource.

9. The method of claim 8, further comprising at least one of: modifying the initial text content in the text region based on a received first editing operation; or
modifying the initial interaction resource in the resource region based on a received second editing operation.

10. The method of claim 9, wherein modifying the initial interaction resource in the resource region comprises at least one of:
replacing the initial interaction resource with a first interaction resource;
adding a second interaction resource to the resource region;
deleting a third interaction resource in the resource region.

11. An electronic device, comprising:
at least one processor; and
at least one memory coupled to the at least one processor and storing instructions to be executed by the at least one processor, the instruction, when executed by the at least one processor, cause the electronic device to implement acts comprising:
in response to receiving a sharing request for an avatar created by a user, presenting a sharing window, wherein the sharing window comprises a message editing component, the message editing component comprises a text region and a resource region, and at least one of the text region and the resource region is an editable region supporting content editing;
generating a target message based on an input content of the message editing component, wherein the target message comprises a text content in the text region and at least one interaction resource in the resource region, and the at least one interaction resource is generated based on the created avatar; and
sending the target message to a session associated with at least one object to be share.

12. The electronic device of claim 11, wherein the acts further comprise:
triggering a client associated with the at least one object to present the target message and an interaction portal associated with the target message in a session interface of the session.

13. The electronic device of claim 12, wherein the avatar is a first avatar;
in response to that the at least one object has a corresponding second avatar, the interaction portal comprises a first interaction portal, and the first interaction portal is used to generate an interaction resource corresponding to the second avatar; or
in response to that the at least one object has no a corresponding avatar, the interaction portal comprises a second interaction portal, and the second interaction portal is used to generate an avatar corresponding to the at least one object.

14. The electronic device of claim 11, wherein the acts further comprise:
presenting a set of candidate objects in the sharing window, wherein the set of candidate objects comprises a user object and/or a group object; and
receiving a selection for the at least one object in the set of candidate objects.

15. The electronic device of claim 11, wherein the at least one object comprises a plurality of objects, and sending the target message to the session associated with at least one object to be shared comprises:
creating a new session associated with the plurality of objects; and
sending the target message to the created new session.

16. The electronic device of claim 15, wherein creating a new session associated with the plurality of objects comprises:
receiving a session creation request based on a configuration control in the sharing window; and
creating the new session associated with the plurality of objects based on the session creation request.

17. The electronic device of claim 11, wherein the at least one object comprises a plurality of objects, and sending the target message to a session associated with at least one object to be shared comprises:
sending the target message to a plurality of sessions corresponding to the plurality of objects respectively.

18. The electronic device of claim 11, wherein:
the text region is configured to present an initial text content; and/or
the resource region is configured to present an initial interaction resource.

19. The electronic device of claim 18, wherein the acts further comprise:
modifying the initial text content in the text region based on a received first editing operation; and/or
modifying the initial interaction resource in the resource region based on a received second editing operation.

20. A non-transitory computer readable storage medium having a computer program stored thereon, wherein the computer program is executed by a processor to implement acts comprising:
in response to receiving a sharing request for an avatar created by a user, presenting a sharing window, wherein the sharing window comprises a message editing component, the message editing component comprises a text region and a resource region, and at least one of the text region or the resource region is an editable region supporting content editing;
generating a target message based on an input content of the message editing component, wherein the target message comprises a text content in the text region and at least one interaction resource in the resource region, and the at least one interaction resource is generated based on the created avatar; and
sending the target message to a session associated with at least one object to be share.
